(19) United States
(12) Patent Application Publication
(10) Pub. No.: US 2025/0087025 A1
(43) Pub. Date: Mar. 13, 2025

(54) ATTENTIVE SENSING FOR EFFICIENT MULTIMODAL GESTURE RECOGNITION

(71) Applicant: Samsung Electronics Co., Ltd., Gyeonggi-do (KR)

(72) Inventors: Mostafa EL-KHAMY, San Diego, CA (US); Soheil HOR, Sunnyvale, CA (US); Yanlin ZHOU, San Diego, CA (US)

(21) Appl. No.: 18/882,626

(22) Filed: Sep. 11, 2024

Related U.S. Application Data
(60) Provisional application No. 63/582,052, filed on Sep. 12, 2023.

(51) Int. Cl. G06V 40/20

(52) U.S. Cl. CPC G06V 40/20

(57) ABSTRACT

A system and a method for performing gesture recognition are disclosed, the method comprising detecting a gesture using a primary modality; evaluating an expected accuracy gain (EAG) to identify a modality that yields a maximum relative EAG among the primary modality and one or more secondary modalities; and activating the one or more secondary modalities for detecting the gesture if the one or more secondary modalities correspond to the modality that yields the maximum relative EAG.

### CROSS-REFERENCE TO RELATED APPLICATION

This application claims the priority benefit under 35 U.S.C. § 119 (e) of U.S. Provisional Application No. 63/582,052, filed on Sep. 12, 2023, the disclosure of which is incorporated by reference in its entirety as if fully set forth herein.

### TECHNICAL FIELD

The disclosure relates generally to hand gesture recognition systems. More particularly, the subject matter disclosed herein relates to improvements to multimodal hand gesture recognition systems employing adaptive sensing and progressive adaptation techniques.

### SUMMARY

Hand gesture recognition systems are an integral part of modern interactive technology, especially in applications involving augmented reality (AR) and virtual reality (VR). These systems traditionally utilize synchronized streams of red blue green (RGB), depth, and flow images to accurately identify various hand gestures. The incorporation of multiple data sources, such as RGB images, depth maps (RGBD), and optical flow, allows these systems to perform joint recognition and classification of hand poses and motions effectively. This integration through deep neural networks significantly enhances gesture recognition accuracy by providing complementary information from each modality, thereby improving upon the capabilities offered by single modality systems.

However, the increased performance and robustness offered by these multimodal systems often come at the cost of greater complexity and heightened resource requirements. This poses a significant challenge, especially in the context of modern resource-limited systems like AR/VR glasses or lenses.

To address the demand for power efficiency, prior solutions have explored avenues such as reducing the power consumption of sensing systems. For example, this has been attempted both at the sensor level, through methods like compressed sensing, and at the neural network level, via neural network compression techniques. Despite these efforts, existing solutions have fallen short in meeting the comprehensive efficiency requirements essential for advanced gesture recognition systems.

One issue with the current approaches is their static nature in the design and optimization of the sensing systems. These systems often fail to adapt to the varying complexities and nuances of different hand gestures. This static approach leads to inefficiencies, as the system may not optimally manage its power and computational demands across a diverse range of gesture sequences, thereby negatively affecting recognition accuracy and system responsiveness.

Furthermore, in scenarios in which the sensing power cost is significant, the sensing front-end (e.g., the camera sensor, depth sensor, and/or corresponding image signal processing units (ISPs)) may only be used for frames that will eventually be processed by the gesture classifier. This can considerably improve the efficiency of a gesture recognition system and may form a basis of intuition to apply cross-modality adaptive methods and frame-rate adaptive methods.

To address these shortcomings, the present disclosure introduces an adaptive multimodal hand gesture recognition system. This system represents a paradigm shift in hand gesture recognition technology, as it dynamically adjusts the significance and use of different modalities, such as RGB, depth, optical flow, and doppler, based on the specific gesture class being recognized. The system may use adaptive sensing that allows the entire sensing system, including both the sensor and the perception models, to adapt in response to the complexity of the task at hand. Additionally, the disclosure proposes progressive multi-step adaptation, where classifications at different time scales serve as probes for subsequent steps, allowing for more nuanced and accurate gesture recognition.

In real-time scenarios, a sliding window approach can also be adopted. For example, this may involve preparing the input as a sequence of frames in a sliding window format, where the frame rates and modalities used for measurement in one instance inform and adapt future frame rate and modality decisions, particularly helpful for sequences of consecutive gestures.

Another aspect of this system is the implementation of channel attention and channel swapping techniques. By selectively exchanging and reweighting channels across the RGB, depth, and flow modalities, the system facilitates vital information exchange not found in previous works. The network can be designed to learn specialized convolutional filters for each synthetic channel, thereby capturing cross-modality correlations that are inaccessible to standard fusion techniques.

These advancements collectively contribute to a system that is dynamic and adaptive, as well as significantly more efficient in its resource management than prior systems. By utilizing an initial guess to devise an optimum sensing strategy, the system adaptively tailors its power and computational capabilities to the task's complexity, aiming to save both sensing power and perception computation power while maximizing recognition accuracy. This makes the system particularly suitable for deployment in resource-constrained environments, such as AR/VR systems, where efficiency and accuracy must be carefully considered.

In an embodiment, a method for performing gesture recognition comprises detecting a gesture using a primary modality; evaluating an EAG to identify a modality that yields a maximum relative EAG among the primary modality and one or more secondary modalities; and activating the one or more secondary modalities for detecting the gesture if the one or more secondary modalities correspond to the modality that yields the maximum relative EAG

In an embodiment, an electronic device for performing gesture recognition comprises a processor, and a memory storing instructions that, when executed by the processor, cause the processor to detect a gesture using a primary modality; evaluate an EAG to identify a modality that yields a maximum relative EAG among the primary modality and one or more secondary modalities; and activate the one or more secondary modalities for detecting the gesture if the one or more secondary modalities correspond to the modality that yields the maximum relative EAG.

### BRIEF DESCRIPTION OF THE DRAWING

In the following section, the aspects of the subject matter disclosed herein will be described with reference to exemplary embodiments illustrated in the figures, in which:

FIG. 1 illustrates capturing and analyzing frames of gestures based on a gesture duration, according to an embodiment;

FIG. 2 illustrates a flowchart of the adaptive sensing approach, according to an embodiment;

FIG. 3 illustrates a comparison of a static frame-rate approach versus a proposed single modal dynamic frame-rate approach, according to an embodiment;

FIG. 4 is a flowchart illustrating a method of a single-modal dynamic frame-rate approach, according to an embodiment;

FIG. 5 illustrates a comparison of a static frame-rate approach versus a proposed multi modal dynamic frame-rate approach, according to an embodiment;

FIG. 6 is a flowchart illustrating a method of a multi-modal dynamic frame-rate approach, according to an embodiment;

FIG. 7 illustrates a streaming scenario in which input is designated as sliding frames, according to an embodiment;

FIG. 8 illustrates a schematic representation of a channel attention module, according to an embodiment;

FIG. 9 illustrates a schematic representation of a channel swapping module, according to an embodiment;

FIG. 10 is a flowchart illustrating a method for performing gesture recognition, according to an embodiment; and

FIG. 11 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and case of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

As used herein, the term “sensor” refers to any device that measures a physical quantity, such as light, sound, or motion, and converts it into an electrical signal for processing. In a gesture recognition system, typical sensors might include cameras that capture RGB (visible light) images, depth sensors that use various technologies to measure the distance to objects, and motion sensors that might detect specific types of movement. Other types of sensors may be employed.

As used herein, the term “modality” refers to the kind of data being captured or the method of observation used by the sensor. For example, an RGB camera provides visual modality in the form of color images, a depth camera offers depth modality by capturing the third dimension of the observed scene, and a motion sensor provides flow modality by tracking the movement or changes in the position of objects over time.

In the area of gesture recognition, different modalities, including RGB images, depth maps, and optical flow, provide varying levels of accuracy for different gestures. These modalities, when combined, offer a comprehensive understanding of hand movements and positions, which is useful for accurate gesture recognition. However, the effectiveness of each modality can vary significantly depending on various information, such as the specific gesture being performed. Recognizing this variance, prior knowledge about potential gesture candidates can be used to selectively choose the most informative modalities for each gesture. This approach results in more reliable gesture recognition, as the system focuses on modalities that provide the highest accuracy for a given gesture (or class of gestures). The strategic selection of modalities is expected to improve the performance of the sensing system without incurring significant computational resources.

Multimodal perception, while offering enhanced recognition capabilities, is inherently costly in terms of the energy required for both sensing and computation. The solutions proposed herein recognize that for certain gesture classes, the use of multiple modalities is may degrade performance. In light of this, the system incorporates a knowledge-driven approach where prior understanding of potential gesture candidates informs the decision on when to perform modality fusion (e.g., using one or more modalities or sensors in combination or in particular durations). By selectively fusing modalities when it benefits gesture recognition, the system effectively reduces the power consumption associated with multimodal sensing. This tailored approach to modality fusion, guided by pre-identified gesture characteristics, aims to maintain high recognition performance while minimizing energy expenditure.

Moreover, the size and complexity of modality-fusion models do not uniformly benefit all gesture classes. In some instances, employing larger, more complex fusion models offers no substantial advantage over smaller, less complex models. By utilizing prior knowledge about potential gesture candidates, the system can discern when the deployment of larger fusion models is warranted and when smaller models suffice.

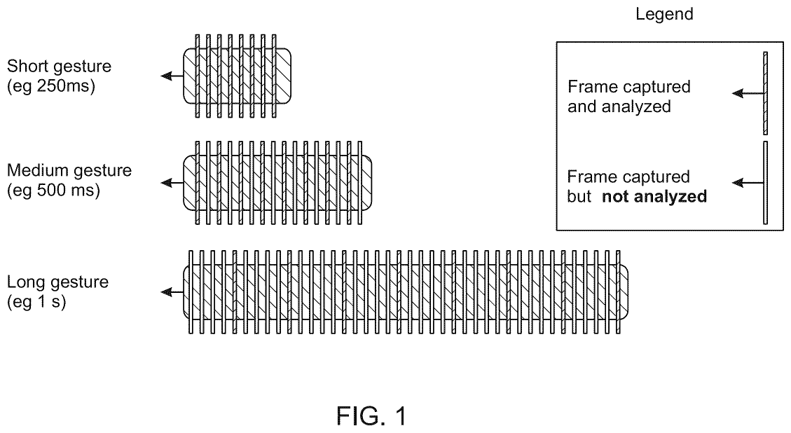

FIG. 1 illustrates capturing and analyzing frames of gestures based on a gesture duration, according to an embodiment.

FIG. 1 illustrates a manner in which a gesture recognition model (e.g., ACTION-Net) may be applied to evaluate a dataset comprising separate and fused modalities for hand gesture recognition.

Referring to FIG. 1, a gesture recognition model operates under the assumption that the duration of the hand gesture (short, medium, or long) is predetermined, which can be established by a preliminary gesture detection mechanism capable of accurately identifying the start and end of a gesture. Once a gesture is detected and completed, gesture recognition may be initiated.

The gesture recognition model is configured to process a fixed number of frames extracted uniformly from the entire duration of the detected gesture, regardless of the gesture's length. As shown in FIG. 1, the model consistently analyzes eight frames, evenly spaced throughout the gesture sequence. This is depicted by the vertical bars within the observation window, where the solid bars represent frames that are captured and analyzed, and the hollow bars represent frames that are captured but not analyzed.

The uniform frame sampling is demonstrated across gestures of varying durations: short (e.g., 250 milliseconds (ms)), medium (e.g., 500 ms), and long (e.g., 1 second(s)). Despite the differing lengths of these gestures, the model maintains a constant observation window size, ensuring that the number of analyzed frames remains unchanged. This methodology facilitates a consistent number of solid bars (analyzed frames) in each gesture duration within FIG. 1.

The dataset employed in this example, referred to for illustrative purposes as an EgoGesture dataset, serves as a comprehensive test-bed for both gesture classification in segmented data and gesture detection in continuous data streams. This dataset may encompass a significant volume of RGBD videos, gesture samples, and individual frames, contributed by a diverse pool of subjects, and may include a wide array of gesture classes pertinent to interactions with wearable devices. While the EgoGesture dataset is mentioned specifically in this context, the principles are applicable to a variety of large-scale datasets designed for hand gesture recognition.

Certain modalities may yield higher accuracy for specific gestures. This implies that an informed initial guess regarding the gesture class can direct the system towards selecting the modality likely to achieve better accuracy for that particular instance. This selective modality usage may favor a more strategic, resource-efficient approach.

In addition, the fusion of two modalities does not always enhance model performance. In some cases, the addition of multiple modalities may introduce uncertainty rather than clarity, leading to suboptimal performance. This suggests that it may be advantageous to employ multimodal classification selectively, only when it concretely benefits classification accuracy over a single-modal approach.

Additionally, the relationship between the size of a fusion model and its accuracy is not linear. For certain gestures, a larger fusion model does not necessarily equate to higher accuracy. In fact, late fusion, which is more computationally intensive than early fusion, does not always yield better results. This points towards the potential for computational savings by avoiding late fusion when early fusion proves sufficient for accurate recognition.

Furthermore, while the initial frames of a gesture may not be enough to enable reliable recognition on their own (although sometimes they may), they may include valuable information that can inform the subsequent recognition process. These early frames can provide preliminary data that influences the choice of modality and fusion method, without the necessity of processing the entire gesture.

Accordingly, devising a method for accumulating prior knowledge about potential gesture candidates efficiently, without expending resources on capturing and processing data from multiple modalities, may be highly beneficial. This could involve initial sampling of frames or modalities, predictive modeling based on early gesture data, or other methods that reduce the need for extensive data capture and processing, thus ensuring that the system remains resource-efficient while maintaining high recognition performance.

According to an embodiment, adaptive sensing for multimodal gesture recognition can be employed.

This approach introduces an optimized technique for hand gesture recognition by making an “initial guess” on potential gesture candidates using a limited observation window. This strategy emphasizes making a determination of whether (or how) to engage in a more extensive analysis based on the data gathered from the initial frames of the gesture.

The adaptive sensing approach makes such an “initial guess” about the gesture class using a preliminary model, hereinafter referred to as “the probe” classifier. This probe classifier acts as an initial filter, making a quick assessment of the gesture before the system commits additional resources for more detailed analysis.

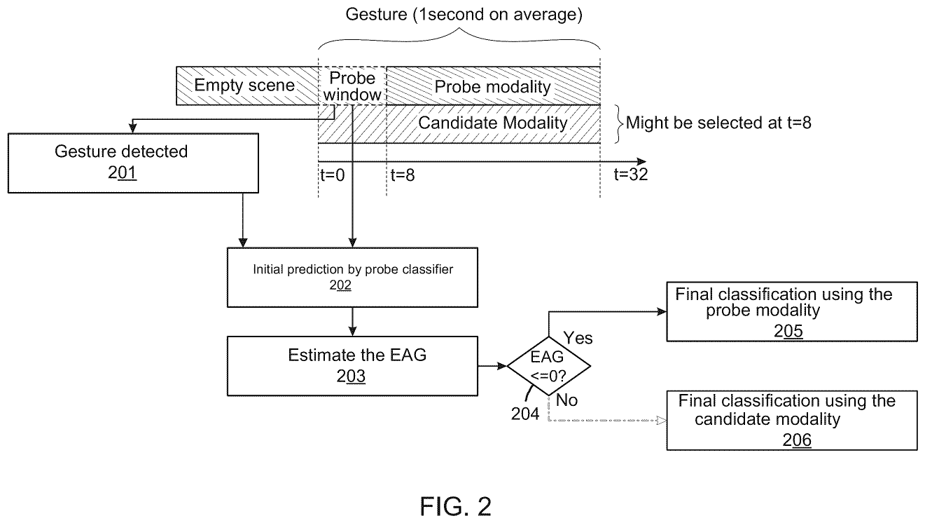

The probe classifier is flexible in its modality. It may be multimodal, employing a combination of inputs such as RGB and RGBD with early or late fusion, or it could be single-modal, relying solely on data from one type of sensor. The observation window for the probe classifier is relatively short compared to the full duration of the gesture, but it is sufficiently long to make a preliminary classification. The observation window can range from a single frame to several frames, as long as it is brief relative to the gesture's total length. For example, the probe window (e.g., the observation window) may be t=8, whereas the gesture's total length may be t=32 (as illustrated in FIG. 2).

A critical consideration in the design of neural network accelerators is the energy cost associated with memory access, which is predominantly consumed by loading and reloading weights. This cost can exceed the energy required for the actual computational inference. Consequently, reusing the weights from the probe classifier for subsequent prediction steps is a strategy that enhances efficiency. Moreover, certain neural networks, like ACTION-Net, for example, are capable of handling inputs of varying sizes without necessitating any changes to the network weights. Thus, employing a network that can both act as an accurate probe classifier and also serve as a “candidate” classifier for the final gesture classification may be helpful.

The probe classifier's role is to quickly estimate the gesture class, while the candidate classifiers are a collection of models and are optimized for the highest accuracy, given full access to the entire gesture sequence. The aim of the candidate classifiers is to utilize the initial insight provided by the probe classifier to select the most suitable classifier from among the candidate classifiers for the final, precise gesture classification. This selection process may include multi-modal or single-modal candidate classifiers, but it is assumed that at least one default option exists which utilizes the same modality and weights as the probe classifier.

A default option, which employs the same modality and weights as the probe, and one additional candidate classifier, which may differ in modality, computational complexity, or both, may comprise the candidate classifier list. In this case, the adaptive sensing challenge is then simplified to deciding whether to maintain the status quo with the probe/default classifier or switch to the alternative/candidate classifier.

FIG. 2 illustrates a flowchart of the adaptive sensing approach, according to an embodiment.

Referring to FIG. 2, as discussed above, the initial probe window of a gesture may have a duration from t=0 to t=8. In this case, at step 201 a gesture is detected. The gesture may be detected by a routine (such as an algorithm or stored instructions), signaling the beginning of the recognition sequence. In step 202, the probe classifier makes an initial prediction based on the information in the prove window after the gesture is detected in step 201. Then in step 203, the system estimates the expected accuracy gain (EAG) from switching classifiers. This EAG may be based on pre-calculated accuracy gain priors for each class, computed offline. In step 204, the system determines if the EAG is less than or equal to zero. If the system determines that the EAG is less than or equal to zero, then the probe modality is used for final classification in step 205. On the other hand, if the EAG is greater than zero, as determined in step 204, indicating a potential accuracy benefit from switching, the candidate modality is used to achieve the final classification in step 206. The EAG is described in further detail, below.

In the context of the adaptive multimodal sensing system, an objective is to allocate resources by switching to an alternative classifier only when an accuracy gain is anticipated, quantified as the EAG. The EAG is an estimation of improvement in classification performance that could be realized by switching from the probe classifier, designated as S₀, to an alternative candidate classifier, designated as S₁, given an input x. The EAG is formulated based on Equation 1, below.

$$E A {G}_{( S 0 , S 1 )} ( x ) = P ( {\overline{Υ}}_{S 1} = {Y}_{GT} , {\overline{Υ}}_{S 0} \neq {Y}_{GT} \vert x ) \qquad Equation 1$$

Here, Y̅_{S} represents the label predicted by classifiers for the given input x, and Y_{GT} is the ground truth label. To determine EAG, the true knowledge of Y̅_{S} should be obtained, which requires running each candidate classifier over the complete gesture, which would negate the efficiency goals of the adaptive approach. Therefore, a proposed solution seeks to estimate the EAG for each instance based on the initial information provided by the probe classifier.

The EAG between the candidate classifiers may be a function of the ground truth label (and not other co-factors). This assumption (for explanatory purposes) may be used to simplify Equation 1 into Equation 2, below.

$$E A {G}_{( S 0 , S 1 )} ( x ) = P ( {\overline{Υ}}_{S 1} = {Y}_{GT} , {\overline{Υ}}_{S 0} \neq {Y}_{GT} \vert {Y}_{GT} ) P ( Y = {Y}_{GT} \vert x ) \qquad Equation 2$$

The first term in Equation 2, P(Y̅_{S1}=Y_{GT}, Y̅_{S0}≠Y_{GT}|Y_{GT}), known as the accuracy gain prior, can be computed offline using a validation set. The second term, P(Y=Y_{GT}|x), represents the probe classifier's best estimate of the ground truth class.

The accuracy gain prior term, defined as a value that can be computed offline and is presumed to be known (or pre-computed) for each class, solely depends on the gesture characteristics. This term may be derived from extensive cross-validation using different candidate models over a dataset (e.g., the EgoGesture dataset). This method assumes the accuracy gain priors remain applicable when models trained on the full dataset are evaluated against a separate test split.

A simple method (herein referred to as the “P method”) to estimate the second term assumes that the probe classifier's output (e.g., class probabilities from the model's final SoftMax layer) accurately reflects the probability (P) of each class. One approach to estimate the class P after sensing a number of frames, is to evaluate the model's confidence in each class using the logits (or from the SoftMax function) at the final layer of the probe classifier. However, this method relies on the assumption that the classifier is well-calibrated for each number of designated sensing frames, which often isn't the case, especially with models trained using categorical cross entropy loss. Furthermore, this method presumes that the probe classifier's predictions are well-calibrated, which is also not always the case, especially with models trained using categorical cross-entropy loss.

Alternative methods to estimate the second term include the top-k and top-k confidence-weighted (top-kp) method approaches. In the top-k method, the list of top-k most likely classes (at the designated sensing step) are considered, and the class P over these top-k classes only are calculated. This approach is less reliant on the mode's calibration as it distributes confidence over multiple predictions, wherein this case, “k” is a hyperparameter that indicates the degree of confidence in the probe model's predictions. For instance, k=1 suggests complete reliance on the probe model's top prediction, while higher k values distribute the confidence over multiple predictions.

The top-kp method combines principles of the top-k and P methods and, therefore, may outperform the top-k and P methods. The top-kp method calculates the EAG using the top-k probabilities from the probe classifier, with k acting as a measure of trust in the probe model relative to the average accuracy difference between the probe and candidate modalities.

To acquire an accurate estimate of accuracy gain priors for each class (referred to as “ACCG”), a training set is randomly divided into N-folds, ensuring that each fold includes samples from different subjects. Then one of the folds is removed as a validation set, and all the models (including different modalities and different fusion methods) on the rest of the folds are trained. The same process is repeated for each fold. This results in a prediction from each single-modal and multimodal model for each fold (and each instance). Then the accuracy difference between different models (as a function of the ground truth class) is used as a proxy of the ACCG for the final model that is trained on all the folds combined.

The adaptive multimodal sensing system proposed herein is designed to flexibly navigate through a range of scenarios by employing different adaptation strategies to optimize resource usage without compromising gesture recognition performance. These strategies may include but are not limited to a modalities on demand scenario, adaptive sensor power-off scenario, and a computation adaptation scenario. Portions of some or all of the scenarios may be used in combination with each other.

In the modalities on demand scenario, the system assumes that at least one modality, such as either RGB or depth (e.g., RGBD) (referred to as the probe modality), is active continuously. The initial gesture classification is made using the probe modality to analyze the first 8 frames of the detected gesture. Based on this initial analysis, the adaptation routine decides whether to continue utilizing the probe modality exclusively or to activate and fuse the other modality (the candidate classifier) with it. A goal is to avoid unnecessary power consumption by engaging additional modalities only when they significantly contribute to recognition accuracy. This approach is beneficial when the RGB sensor serves as the probe modality, given that the depth sensor typically has a higher power demand than the RGB sensor. Conversely, selecting the depth sensor as the probe modality can be advantageous in scenarios where it is already in use for other applications, such as hand detection or simultaneous localization and mapping (SLAM).

Complementing the modalities on demand scenario, an adaptive sensor power off scenario focuses on the potential to power off sensors to conserve energy. In this case, it is presumed that both depth and RGB sensors are initially active and their data is fused using an early fusion approach (RGBD-early). Utilizing insights from the initial 8 frames and a multimodal classifier, the system determines whether one of the sensors can be powered off without significantly impacting the classification accuracy. This scenario emphasizes the reduction of sensor operation when the contribution to performance is marginal.

The preceding modalities on demand and adaptive sensor power-off scenarios assumed that the probe and candidate classifiers have similar computational complexities. However, in a computational adaptation scenario, a two-step approach may be applied to decide between two different classifiers with different computational demands. One classifier is a multimodal approach with complexity similar to a single-modal classifier (RGBD-early), while the other is a more resource-intensive but accurate multimodal classifier (RGBD-late). This scenario explores the system's ability to self-adapt for enhanced performance by judiciously allocating computational resources based on the demands of the gesture recognition task.

This computation adaptation scenario may outperform both the modalities on demand scenario and the adaptive sensor power-off scenario. This counterintuitive result arises from the adaptive scheme's resemblance to a dynamic ensemble of classifiers, which is generally more accurate than any individual classifier in the ensemble. Typically, each model within an ensemble may not be highly accurate on its own, but their independence makes the combined output more reliable. The success of the proposed adaptive method hinges on the diversity of the classifiers, which renders them complementary for certain classes. By leveraging the initial guess and pre-calculated priors, the adaptive method selects the most suitable classifier for each specific instance, potentially achieving an operating point that surpasses the accuracy of both individual candidate models.

According to an embodiment, a sequential multi-step adaptation approach that enhances the flexibility and efficiency of the gesture recognition system may be provided. This approach builds upon the foundational 2-step method, which utilizes a probe classifier to make an initial assessment and then selects from two or more candidate classifiers or modalities for final gesture classification.

This sequential multi-step method involves using classifications made at varying time scales as probes for subsequent steps. A challenge with this method is cross-modal adaptation over multiple time scales; if a modality is deactivated early in the process, subsequent steps cannot use it for further refinement. To address this, the proposed system employs an adaptive frame rate strategy for the input sensor.

Certain model families, which might be used as candidate classifiers, require a fixed number of time-equally spaced frames for their input, irrespective of the actual length of the gesture being recognized. Consequently, as the length of the gesture increases, the effective processing frame rate of the model decreases. In other words, the same total number of frames are processed, even if the gesture is longer. This insight was described in above in FIG. 1 and allows for a reduction in the sensor's frame rate as the gesture progresses in time, as most frames will not be processed by the classifier anyway.

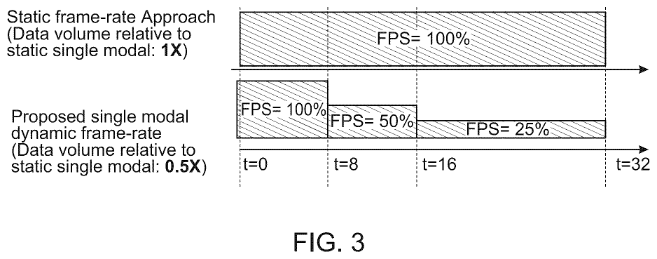

FIG. 3 illustrates a comparison of a static frame-rate approach versus a proposed single modal dynamic frame-rate approach, according to an embodiment.

Referring to FIG. 3, a comparison between a static frame-rate approach and the proposed dynamic frame-rate approach for a single modality is shown. In the static scenario, the frames per second (FPS) is constant throughout the duration of the gesture, leading to a data volume that is represented as 1X. This means the sensor may operate at full capacity, capturing frames at a consistent rate.

In contrast, the proposed single modal dynamic frame-rate approach shows that the FPS decreases progressively. Initially, at time t=0, the sensor captures frames at 100% of its capacity. As the gesture continues, at time t=8, the FPS is reduced to 50%, and then further reduced to 25% at time t=16. This reduction continues, adapting to the duration of the gesture, effectively lowering the total number of frames captured and processed. By avoiding the sensing or capture of data unlikely to be utilized by the perception (e.g., gesture recognition) routine, the data volume relative to the static single model is halved to 0.5×, illustrating a significant reduction in sensor operation and consequently, power consumption.

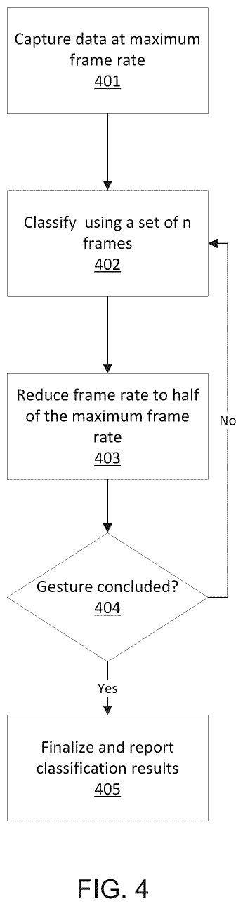

FIG. 4 is a flowchart illustrating a method of a single-modal dynamic frame-rate approach, according to an embodiment.

Referring to FIG. 4, upon detection of a gesture by a gesture detection routine, the system commences data capture at the maximum frame rate in step 401. The routine continues this high-rate capture until a predefined number of frames (n) or more have been collected to allow for an initial classification (e.g., the ACTION-Net model would require 8 frames).

With these frames in hand, the system conducts a classification using a set of n uniformly sampled frames in step 402. Following this initial classification, the system then reduces the frame rate to half of the maximum for the subsequent set of n frames in step 403.

In step 404, the system determines whether the gesture is concluded before a next set of n frames is captured. If the gesture concludes before this next set of n frames is fully captured, the system finalizes and reports the classification results based on the data it has already processed in step 405. However, if the gesture is not concluded before the next set of n frames is fully captured, the system returns to step 402 and perform another classification with the new frames obtained at the reduced frame rate, effectively repeating the process from step 402.

This loop continues, halving the frame rate with each iteration after classification, until the gesture ends. The method thus allows for dynamic adjustment of the frame rate based on the duration of the gesture, optimizing the data capture process and reducing processing.

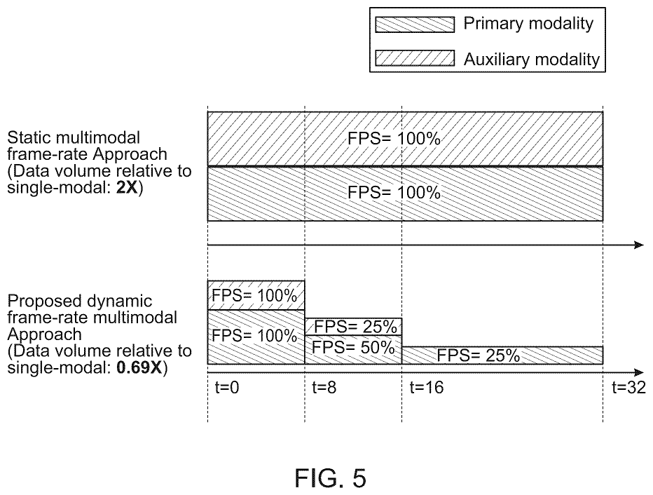

FIG. 5 illustrates a comparison of a static frame-rate approach versus a proposed multi modal dynamic frame-rate approach, according to an embodiment.

Referring to FIG. 5, a static multimodal frame-rate approach is illustrated where two modalities, primary and auxiliary, are capturing data at full capacity (100% FPS), leading to a data volume twice that of a single-modality approach. This approach does not adapt to the actual requirements of the gesture being analyzed and thus may result in unnecessary data processing and increased power consumption.

FIG. 5 also illustrates a proposed dynamic frame-rate multimodal approach, which aims to reduce the unnecessary capture of frames by adapting the frame rate based on the progression of the gesture and probe classifiers at each step. Initially, at time t=0, the primary modality captures data at 100% FPS. As time progresses to t=8, the system evaluates the data and reduces the frame rate for the primary modality to 50% and introduces the auxiliary modality at a reduced rate of 50% FPS. At t=16, the primary modality's frame rate is further reduced to 25% FPS, while the auxiliary modality's frame rate is adjusted to zero. At t=32, the system may continue with the reduced frame rate for the primary modality, suspend it altogether, or adjust it according to the needs assessed at that moment.

This adaptive strategy decreases the data volume relative to the single-modal approach, indicated in the figure as 0.69×. The system schedules the frame rates for the modalities dynamically: the primary modality's frame rate is scheduled to be reduced at each time interval, and the auxiliary modality's frame rate is scheduled to match or to be reduced more significantly, potentially to zero if it is deemed unnecessary for further gesture analysis. The modality to be used in the subsequent steps, along with its corresponding frame rate, is determined based on the findings of the probe classifier at each interval. This proposed method is distinguished by its ability to dynamically adjust the frame rate of each sensing modality, depending on the relevance of multimodal or single-modal fusion for a specific gesture recognition task

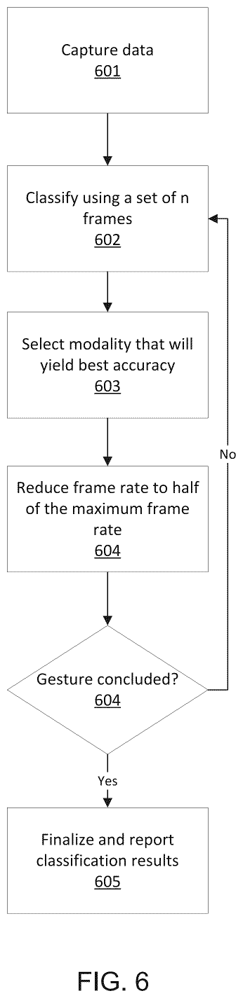

FIG. 6 is a flowchart illustrating a method of a multi-modal dynamic frame-rate approach, according to an embodiment.

Referring to FIG. 6, upon detection of a gesture, the system initiates data capture at the maximum frame rate using the primary modality, which acts as the probe, and simultaneously, the secondary modality, designated as the candidate, begins capturing data at half the maximum frame rate in step 601. This process continues until enough frames (n) are obtained to allow for an initial classification (e.g., for systems like ACTION-Net, typically, n is set to 8 frames).

Once these frames are captured, in step 602 the system conducts a classification using the n uniformly sampled frames from the data collected by the primary modality. Using ACCG priors, the system evaluates which modality (primary or secondary) will yield the best accuracy for the current instance in step 603.

After this evaluation, the system reduces the frame rates of all modalities involved in step 604 (e.g., reducing them by 50% for the capture of the next n frames). This reduction in frame rate aligns with the progressive adaptation strategy, aiming to reduce the processing of unnecessary frames as the gesture continues to unfold.

In step 605, the system determines whether the gesture ends before the next n frames is captured. If the gesture concludes before the new set of n frames is fully captured, the system finalizes the process by reporting the results from the last successful classification in step 606. However, if the gesture continues, the system returns to step 602 to perform the classification process using the new frames captured at the adjusted frame rate.

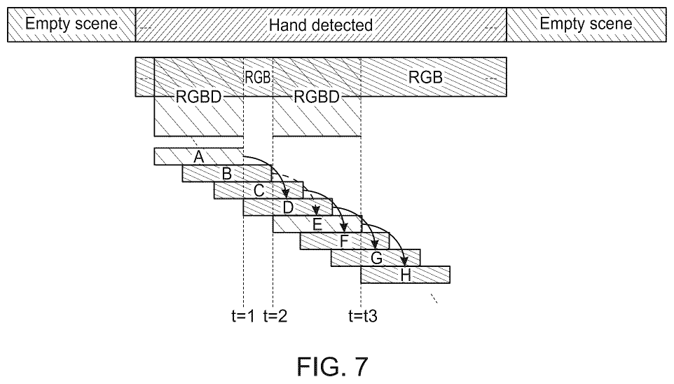

FIG. 7 illustrates a streaming scenario in which input is designated as sliding frames, according to an embodiment.

Referring to FIG. 7, a continuous gesture recognition environment, where the input is processed as a sliding window of frames is shown. The progression of this adaptive process is shown over three timeframes, t=t1, t=t2, and t=t3.

Initially, at cold start, the process begins by capturing data at a maximum frame rate (as described above). As time progresses and a steady stream of frames is received, the system may have already adjusted the frame rates or changed the modalities based on earlier decisions informed by the initial set of frames. The modalities and frame rates determined at each step are then used as a basis for sensing in subsequent frames, which in turn influences future decisions regarding frame rate and modality adjustments.

In the first sliding window, the previously described adaptive sensing approach is applied. However, after this initial sliding window, assuming a fixed frame rate, the classification results from each sliding window are utilized to dictate the modality required for the next non-overlapping window. For example, classifier B, having processed its window of frames, serves as the probe classifier for the following window processed by classifier E, indicating the need for RGBD data. Similarly, classifier C acts as a probe for classifier F, which may only require RGB data, and so on.

If any classifier operating within a specific timeframe requires a certain modality, that modality must be activated. For instance, as depicted in FIG. 7, at t=t1, classifiers B, C, and D do not require depth data, leading to the deactivation of the depth sensor. Moving to t=t2, although classifiers C and D still do not require depth, classifier E does, prompting the reactivation of the depth sensor. By t=t3, classifiers F, G, and H do not require depth information, and thus, the depth sensor is once again deactivated.

By continuously adapting the modality and frame rate based on the immediate needs dictated by the classification results, the system ensures optimal resource utilization, eliminating unnecessary data capture and processing, which is particularly beneficial in scenarios with consecutive gestures.

According to an embodiment, the expected accuracy gain may be directly estimated based on the input instance, and/or the optimum modality may be selected based on the sensed input signal. However, since the weights of the candidate classifiers shouldn't be reused, the probe network (also known as the policy network in dynamic neural network literature such as AR-Net) should be much smaller than the candidate models (also known as backbone models in dynamic neural network literature).

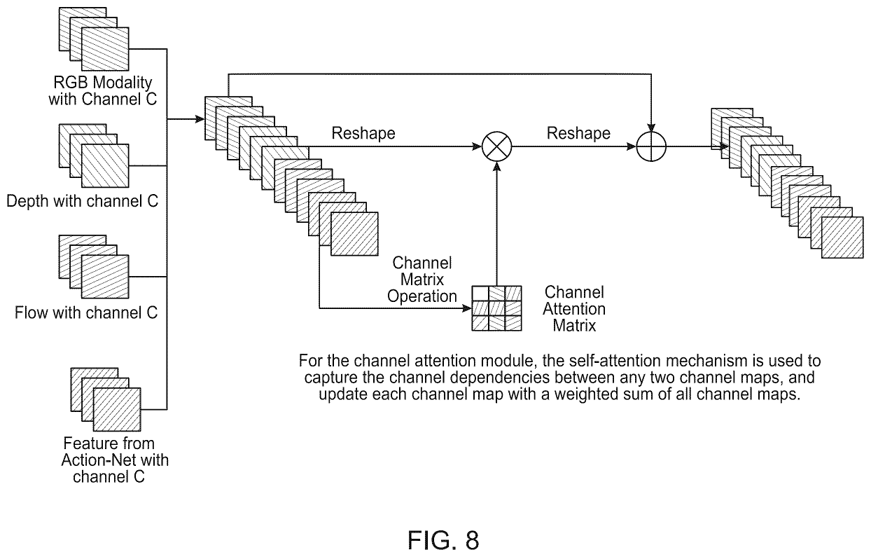

FIG. 8 illustrates a schematic representation of a channel attention module, according to an embodiment.

Referring to FIG. 8, the multimodal hand gesture recognition system may process various input channels from different channels using a self-attention mechanism.

Individual channels such as RGB, depth, and flow modalities, are each labeled as channel C. These channels represent the raw data inputs as well as the processed features extracted after passing through a convolutional network, such as Action-Net. Each channel undergoes a reshaping process to prepare for the attention mechanism.

The self-attention mechanism is employed to capture and quantify the dependencies between any two channel maps across the different modalities. This is accomplished by updating each channel map with a weighted sum of all channel maps, effectively allowing the network to focus on more informative features while diminishing the less relevant ones.

To perform this operation, all input channels are concatenated together, resulting in a combined channel of width of, for example, 4C. Subsequently, a large matrix of dimensions 4C by 4C is constructed to compute pairwise channel dependencies. This matrix operation reveals how each channel relates to the others, creating a channel attention matrix that can direct the network's focus to the most significant features for gesture recognition.

The self-attention mechanism may include a continuous range of values within the channel attention matrix. However, the approach can be adapted to enforce a one-hot encoding scheme within the matrix. This adaptation would allow only a single active channel per row, indicating exclusive selection of the most relevant channel for the given context. This method of using one-hot encoding within the channel attention matrix introduces an element of adaptability, as it imposes a constraint that could lead to more distinct and discrete channel preferences.

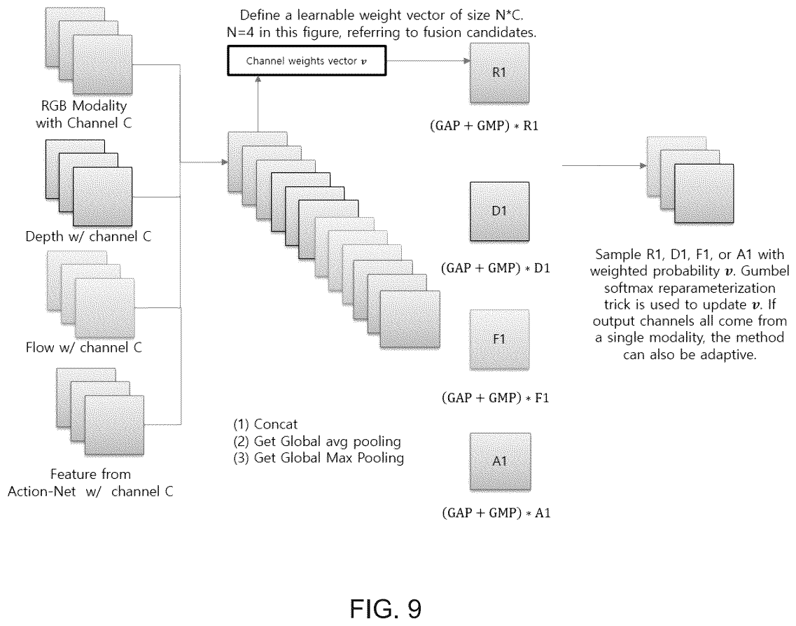

FIG. 9 illustrates a schematic representation of a channel swapping module, according to an embodiment.

Referring to FIG. 9, the multimodal hand gesture recognition system may process various input channels from different channels using a channel swapping mechanism.

The channel swapping model begins by receiving inputs from three different modalities: RGB, depth, and flow, each with a spatial dimension of height (H) and width (W), and a feature dimension defined as C channels. While only three channels are depicted for visual clarity, the actual feature maps derived from convolutions could have more than three channels. These inputs are synthesized into a fixed-size feature map (H×W×C).

A typical 1×1 convolution step is omitted in favor of selecting the best modality for each individual channel. For example, the first channel of the output feature map may be sourced from RGB, while the second channel may be derived from the depth modality, and so on.

The channel swapping module comprises concatenation, pooling, and weighted sampling.

To perform concatenation, the RGB (H×W×C) and depth features (H×W×C) are concatenated along the channel dimension, resulting in a combined feature size (H×W×3C).

To perform pooling, a global average pooling (GAP) and global max pooling (GMP) are computed across the channel dimension of the combined feature to obtain a global descriptor for each channel.

To perform weighted sampling, a learnable weight vector of a predetermined size (e.g., 2C) is initialized, with all entries set to zero initially. This weight vector acts as a probability distribution for channel sampling, implemented through a predefined process such as Gumbel softmax reparameterization, allowing for discrete choices during the forward pass. During the model's forward operation, a channel is probabilistically selected from either the RGB or depth features based on the distribution defined by the learnable weight vector. During the backward pass, this distribution is refined through another predefined process, such as a SoftMax operation.

The selected channel may be multiplied by the sum of GAP and GMP to determine global channel information. This method facilitates adaptive sensing by allowing the system to drop input modalities that are not sampled for the final feature map. Consequently, if the sampled channels predominantly originate from a single modality, the other modalities can be disregarded.

By applying this channel swapping strategy, the system ensures that each channel of the output feature map is populated with the most relevant information from the available modalities.

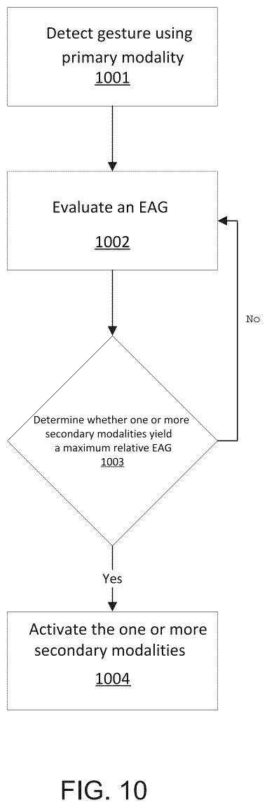

FIG. 10 is a flowchart illustrating a method for performing gesture recognition, according to an embodiment.

Embodiments of the present disclosure, such as the method of FIG. 10, may be implemented by an electronic device including a system for gesture recognition, designed to interface with various sensors. The electronic device may include hardware and software that captures, analyzes, and interprets human hand gestures with high precision and adaptability. Physical sensors capable of detecting visual RGB, RGBD, and motion data may be included in the electronic device.

These sensors may be used to gather data to perform complex computational processes. As discussed above, the system may dynamically adjust the frame rate of data capture to the requirements of the gesture being performed. This may be performed by a controller or processor executing instructions stored on a memory device.

The stored instructions, when executed, may cause the system to learn and adapt over time, employing machine learning techniques to refine the gesture recognition process continually. This learning capability means the system can improve its performance with each interaction, becoming more efficient and precise in recognizing a wide array of gestures using the sensors.

Referring to FIG. 10, in step 1001, a gesture is detected. The gesture may be detected using a primary modality. The modality may be obtained via a sensor, such as an RGB sensor, a depth sensor, or any other sensor capable of obtaining the primary modality. The gesture may be detected during a time period that is less than a total duration of the gesture.

In step 1002, an EAG is evaluated. The EAG may be evaluated to identify a modality that yields a maximum relative EAG among the primary modality and one or more secondary modalities.

In step 1003, it is determined whether one or more secondary modalities yield a maximum relative EAG. In other words, it is determined whether the one or more secondary modalities correspond to the modality that yields the maximum relative EAG. For example, this step may be used to assess whether the gesture should continue being detected (sensed) using the primary and/or one or more secondary modalities. The step may be performed prior to the gesture being completely detected.

In step 1004, one or more secondary modalities are activated if the one or more secondary modalities yield a maximum relative EAG in step 1003. Otherwise, if the one or more secondary modalities do not correspond to the modality that yields the maximum relative EAG, then the EAG may be continued to be evaluated to identify a modality that yields a maximum relative EAG. “Activated” may mean that a power-on command is received by a sensor corresponding to a modality, that a command to begin sensing is received by the sensor, or that data corresponding to a given modality is received from the sensor.

Additional details with regards to the steps shown in FIG. 10 may be supplemented by the description of similar steps shown in FIG. 2.

Embodiments disclosed herein relate to a gesture recognition system implemented within an electronic device. This system includes various sensors and computational modules that dynamically adapt to the complexity of tasks, optimizing both power consumption and computational efficiency. By integrating these components into an electronic device, one or more embodiments disclosed herein ensure efficient data capture and processing, making it highly suitable for use in resource-constrained environments such as AR/VR systems. The electronic device thus exemplifies a practical application of advanced gesture recognition techniques, contributing to the field of human-computer interaction through innovative design and functionality.

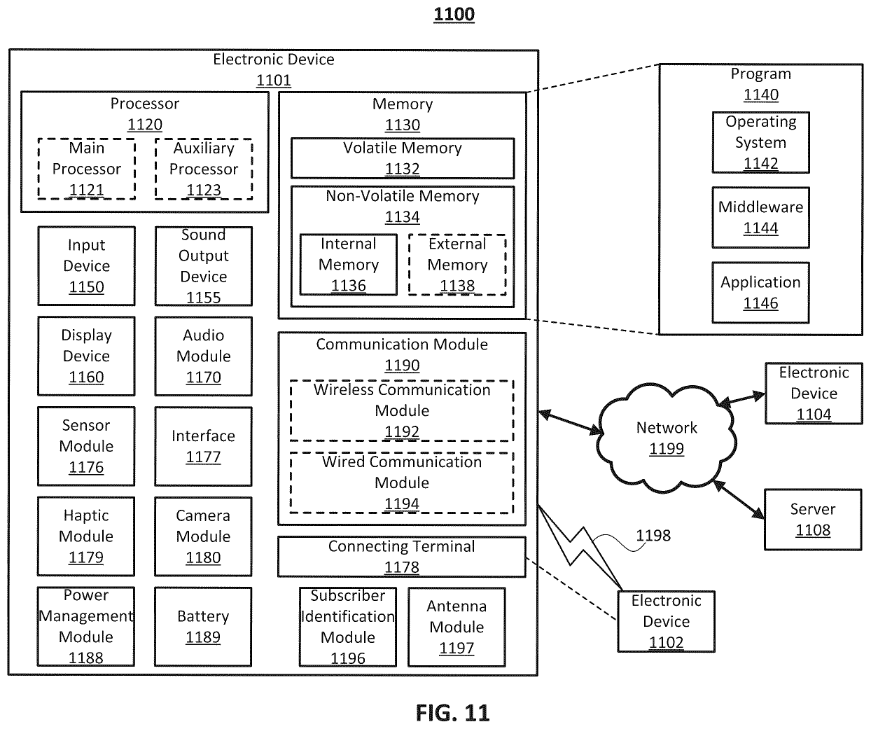

As explained above, the method shown in FIG. 10, as well as other embodiments of the present disclosure, may be performed by an electronic device. Such an electronic device is further described with reference to FIG. 11, below.

FIG. 11 is a block diagram of an electronic device in a network environment, according to an embodiment.

Referring to FIG. 11, an electronic device 1101 in a network environment 1100 may communicate with an electronic device 1102 via a first network 1198 (e.g., a short-range wireless communication network), or an electronic device 1104 or a server 1108 via a second network 1199 (e.g., a long-range wireless communication network). The electronic device 1101 may communicate with the electronic device 1104 via the server 1108. The electronic device 1101 may include a processor 1120, a memory 1130, an input device 1140, a sound output device 1155, a display device 1160, an audio module 1170, a sensor module 1176, an interface 1177, a haptic module 1179, a camera module 1180, a power management module 1188, a battery 1189, a communication module 1190, a subscriber identification module (SIM) card 1196, or an antenna module 1194. In one embodiment, at least one (e.g., the display device 1160 or the camera module 1180) of the components may be omitted from the electronic device 1101, or one or more other components may be added to the electronic device 1101. Some of the components may be implemented as a single integrated circuit (IC). For example, the sensor module 1176 (e.g., a fingerprint sensor, an iris sensor, or an illuminance sensor) may be embedded in the display device 1160 (e.g., a display).

The processor 1120 may execute software (e.g., a program 1140) to control at least one other component (e.g., a hardware or a software component) of the electronic device 1101 coupled with the processor 1120 and may perform various data processing or computations.

As at least part of the data processing or computations, the processor 1120 may load a command or data received from another component (e.g., the sensor module 1146 or the communication module 1190) in volatile memory 1132, process the command or the data stored in the volatile memory 1132, and store resulting data in non-volatile memory 1134. The processor 1120 may include a main processor 1121 (e.g., a central processing unit (CPU) or an application processor (AP)), and an auxiliary processor 1123 (e.g., a graphics processing unit (GPU), an image signal processor, a sensor hub processor, or a communication processor (CP)) that is operable independently from, or in conjunction with, the main processor 1121. Additionally or alternatively, the auxiliary processor 1123 may be adapted to consume less power than the main processor 1121, or execute a particular function. The auxiliary processor 1123 may be implemented as being separate from, or a part of, the main processor 1121.

The auxiliary processor 1123 may control at least some of the functions or states related to at least one component (e.g., the display device 1160, the sensor module 1176, or the communication module 1190) among the components of the electronic device 1101, instead of the main processor 1121 while the main processor 1121 is in an inactive (e.g., sleep) state, or together with the main processor 1121 while the main processor 1121 is in an active state (e.g., executing an application). The auxiliary processor 1123 (e.g., an image signal processor or a communication processor) may be implemented as part of another component (e.g., the camera module 1180 or the communication module 1190) functionally related to the auxiliary processor 1123.

The memory 1130 may store various data used by at least one component (e.g., the processor 1120 or the sensor module 1176) of the electronic device 1101. The various data may include, for example, software (e.g., the program 1140) and input data or output data for a command related thereto. The memory 1130 may include the volatile memory 1132 or the non-volatile memory 1134.

The program 1140 may be stored in the memory 1130 as software, and may include, for example, an operating system (OS) 1142, middleware 1144, or an application 1146.

The input device 1150 may receive a command or data to be used by another component (e.g., the processor 1120) of the electronic device 1101, from the outside (e.g., a user) of the electronic device 1101. The input device 1150 may include, for example, a microphone, a mouse, or a keyboard.

The sound output device 1155 may output sound signals to the outside of the electronic device 1101. The sound output device 1155 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 1160 may visually provide information to the outside (e.g., a user) of the electronic device 1101. The display device 1160 may include, for example, a display, a hologram device, or a projector and control circuitry to control a corresponding one of the display, hologram device, and projector. The display device 1160 may include touch circuitry adapted to detect a touch, or sensor circuitry (e.g., a pressure sensor) adapted to measure the intensity of force incurred by the touch.

The audio module 1170 may convert a sound into an electrical signal and vice versa. The audio module 1170 may obtain the sound via the input device 1150 or output the sound via the sound output device 1155 or a headphone of an external electronic device 1102 directly (e.g., wired) or wirelessly coupled with the electronic device 1101.

The sensor module 1176 may detect an operational state (e.g., power or temperature) of the electronic device 1101 or an environmental state (e.g., a state of a user) external to the electronic device 1101, and then generate an electrical signal or data value corresponding to the detected state. The sensor module 1176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1177 may support one or more specified protocols to be used for the electronic device 1101 to be coupled with the external electronic device 1102 directly (e.g., wired) or wirelessly. The interface 1177 may include, for example, a high-definition multimedia interface (HDMI), a universal serial bus (USB) interface, a secure digital (SD) card interface, or an audio interface.

A connecting terminal 1178 may include a connector via which the electronic device 1101 may be physically connected with the external electronic device 1102. The connecting terminal 1178 may include, for example, an HDMI connector, a USB connector, an SD card connector, or an audio connector (e.g., a headphone connector).

The haptic module 1179 may convert an electrical signal into a mechanical stimulus (e.g., a vibration or a movement) or an electrical stimulus which may be recognized by a user via tactile sensation or kinesthetic sensation. The haptic module 1179 may include, for example, a motor, a piezoelectric element, or an electrical stimulator.

The camera module 1180 may capture a still image or moving images. The camera module 1180 may include one or more lenses, image sensors, image signal processors, or flashes. The power management module 1188 may manage power supplied to the electronic device 1101. The power management module 1188 may be implemented as at least part of, for example, a power management integrated circuit (PMIC).

The battery 1189 may supply power to at least one component of the electronic device 1101. The battery 1189 may include, for example, a primary cell which is not rechargeable, a secondary cell which is rechargeable, or a fuel cell.

The communication module 1190 may support establishing a direct (e.g., wired) communication channel or a wireless communication channel between the electronic device 1101 and the external electronic device (e.g., the electronic device 1102, the electronic device 1104, or the server 1108) and performing communication via the established communication channel. The communication module 1190 may include one or more communication processors that are operable independently from the processor 1120 (e.g., the AP) and supports a direct (e.g., wired) communication or a wireless communication. The communication module 1190 may include a wireless communication module 1192 (e.g., a cellular communication module, a short-range wireless communication module, or a global navigation satellite system (GNSS) communication module) or a wired communication module 1194 (e.g., a local area network (LAN) communication module or a power line communication (PLC) module). A corresponding one of these communication modules may communicate with the external electronic device via the first network 1198 (e.g., a short-range communication network, such as Bluetooth™, wireless-fidelity (Wi-Fi) direct, or a standard of the Infrared Data Association (IrDA)) or the second network 1199 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 1192 may identify and authenticate the electronic device 1101 in a communication network, such as the first network 1198 or the second network 1199, using subscriber information (e.g., international mobile subscriber identity (IMSI)) stored in the subscriber identification module 1196.

The antenna module 1197 may transmit or receive a signal or power to or from the outside (e.g., the external electronic device) of the electronic device 1101. The antenna module 1197 may include one or more antennas, and, therefrom, at least one antenna appropriate for a communication scheme used in the communication network, such as the first network 1198 or the second network 1199, may be selected, for example, by the communication module 1190 (e.g., the wireless communication module 1192). The signal or the power may then be transmitted or received between the communication module 1190 and the external electronic device via the selected at least one antenna.

Commands or data may be transmitted or received between the electronic device 1101 and the external electronic device 1104 via the server 1108 coupled with the second network 1199. Each of the electronic devices 1102 and 1104 may be a device of a same type as, or a different type, from the electronic device 1101. All or some of operations to be executed at the electronic device 1101 may be executed at one or more of the external electronic devices 1102, 1104, or 1108. For example, if the electronic device 1101 should perform a function or a service automatically, or in response to a request from a user or another device, the electronic device 1101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 1101. The electronic device 1101 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method for performing gesture recognition, the method comprising:
detecting a gesture using a primary modality;
evaluating an expected accuracy gain (EAG) to identify a modality that yields a maximum relative EAG among the primary modality and one or more secondary modalities; and
activating the one or more secondary modalities for detecting the gesture if the one or more secondary modalities correspond to the modality that yields the maximum relative EAG.

2. The method of claim 1, further comprising:
detecting a first portion of the gesture for a duration that is less than a duration of an entire length of the gesture.

3. The method of claim 1, further comprising:
determining a probe classifier according to a confidence score for a set of gesture classes, and
determining the EAG based on the probe classifier.

4. The method of claim 3, wherein determining the EAG based on the probe classifier further comprises averaging accuracy gain priors of a subset of the set of gesture classes.

5. The method of claim 4, wherein the accuracy gain priors are determined by dividing a training set of data into a number of folds, and removing one of the folds as a validation set and applying each of the remaining folds to a first type of sensor and a second type of sensor.

6. The method of claim 1, further comprising:
deactivating a first type of sensor in response to the EAG being less than a predefined threshold.

7. The method of claim 1, wherein detecting the gesture further comprises decreasing a frame rate as a time duration of detecting the gesture increases.

8. The method of claim 1, further comprising:
detecting the gesture for a set of frames; and
determining whether the EAG for a subsequent non-overlapping set of frames is greater than or equal to a predefined threshold.

9. The method of claim 1, further comprising:
updating a channel map based on a weighted sum of channel maps.

10. The method of claim 1, further comprising:
updating a channel map based on a weighted probability of channel maps.

11. An electronic device for performing gesture recognition, the electronic device comprising:
a processor; and
a memory storing instruction that, when executed, cause the processor to:
detect a gesture using a primary modality;
evaluate an expected accuracy gain (EAG) to identify a modality that yields a maximum relative EAG among the primary modality and one or more secondary modalities; and
activate the one or more secondary modalities for detecting the gesture if the one or more secondary modalities correspond to the modality that yields the maximum relative EAG.

12. The electronic device of claim 11, wherein the instructions, when executed, further cause the processor to:
detect a first portion of the gesture for a duration that is less than a duration of an entire length of the gesture.

13. The electronic device of claim 11, wherein the instructions, when executed, further cause the processor to:
determine a probe classifier according to a confidence score for a set of gesture classes, and
determine the EAG based on the probe classifier.

14. The electronic device of claim 13, wherein determining the EAG based on the probe classifier further comprises averaging accuracy gain priors of a subset of the set of gesture classes.

15. The electronic device of claim 14, wherein the accuracy gain priors are determined by dividing a training set of data into a number of folds, and removing one of the folds as a validation set and applying each of the remaining folds to a first type of sensor and a second type of sensor.

16. The electronic device of claim 11, wherein the instructions, when executed, further cause the processor to:
deactivate a first type of sensor in response to the EAG being less than a predefined threshold.

17. The electronic device of claim 11, wherein detecting the gesture further comprises decreasing a frame rate as a time duration of detecting the gesture increases.

18. The electronic device of claim 11, wherein the instructions, when executed, further cause the processor to:
detect the gesture for a set of frames; and
determine whether the EAG for a subsequent non-overlapping set of frames is equal to or greater than a predefined threshold.

19. The electronic device of claim 11, wherein the instructions, when executed, further cause the processor to:
update a channel map based on a weighted sum of channel maps.

20. The electronic device of claim 11, wherein the instructions, when executed, further cause the processor to:
update a channel map based on a weighted probability of channel maps.
